(19) United States
(12) Patent Application Publication
(10) Pub. No.: US 2015/0128446 A1
(43) Pub. Date: May 14, 2015

(54) FREEZE DRYER COUNTER-FLOW SHELF CONSTRUCTION AND METHOD

(71) Applicant: Millrock Technology, Inc., Kingston, NY (US)

(72) Inventor: Weijia LING, Bethlehem, PA (US)

(21) Appl. No.: 14/532,257

(22) Filed: Nov. 4, 2014

Related U.S. Application Data
(60) Provisional application No. 61/904,003, filed on Nov. 14, 2013.

(51) Int. Cl. F26B 5/06; F26B 25/08

(52) U.S. Cl. CPC F26B 5/06; F26B 25/08
USPC 34/298; 34/92

(57) ABSTRACT

A shelf for a freeze dryer and method for enhancing temperature uniformity across the shelf. In one embodiment, the shelf has a lower shelf plate and an upper shelf plate mounted on the lower shelf plate and channels in a serpentine pattern are positioned between the upper and lower shelf plates to circulate heating or cooling fluid in a counter-flow pattern therebetween for temperature uniformity. The upper-shelf plate is formed of a temperature conductive material.

### CROSS REFERENCE TO RELATED APPLICATIONS

This application claims the priority of Provisional Patent Application No. 61/904,003 filed Nov. 14, 2013 entitled FREEZE DRYER COUNTER-FLOW SHELF CONSTRUCTION AND METHOD

### BACKGROUND OF THE INVENTION

1. Field of the Invention

The present invention relates to a freeze dryer shelf construction and, more particularly, to such a shelf construction and method that enhances temperature uniformity across the shelf by the use of a counter-flow method.

2. Description of the Background Art

The process of freeze drying is dependent on control of the product temperature by controlling the temperature of a fluid filled shelf. During freezing, variations in shelf temperature can result in heterogeneous nucleation which results in different crystal structures. During primary drying, variations in shelf temperature can result is different drying times, product collapse and other issues that compromise product quality and consistency. Therefore, the temperature uniformity of the shelf is important.

Typical fluid filled shelf designs and fluid paths produce a temperature differential between the inlet and the outlet. During freezing the inlet temperature is much lower than the outlet temperature and during primary drying the inlet temperature is typically higher than the outlet temperature. The temperature differential can be several degrees.

A need has arisen, therefore, for a new and improved shelf design and fluid path to create a substantially uniform temperature across the shelf during freezing and drying stages of the freeze drying process. The shelf of the present invention meets this need.

### BRIEF SUMMARY OF THE INVENTION

Instead of the normal or conventional freeze dryer construction having simple vertical spacers inside a hollow cavity, the shelf and method of the present invention provides a serpentine fluid flow pattern that produces a counter-flow pattern that results in a significantly more uniform shelf temperature. The counter-flow pattern minimizes the temperature differential across the shelf during temperature transition and at constant temperatures both with and without product placed on it. Performance of shelf systems on freeze dryers is typically specified when they are dry and empty. The present construction and method improves the uniformity in a dry and empty system, and additionally dramatically improves temperature uniformity with loaded vials and/or product.

Better temperature uniformity greatly improves the quality of the freeze dried product and enables reduced freeze drying process times. The result of better temperature uniformity during freezing is a more consistent ice structure which enables shorter primary drying due to the vials drying at the same rate. In addition, the uniform shelf temperature enables the shelf temperature to be controlled closer to the product critical temperature during primary drying, further reducing primary drying times.

In accordance with one embodiment, the shelf comprises a lower shelf plate and an upper shelf plate mounted on the lower shelf plate and on which product to be freeze dried can be mounted in vials or other containers. Piping of any suitable type is connected in any suitable location to the upper shelf plate for circulating a cooling or heating fluid through channels positioned between the upper and lower shelf plates in a serpentine pattern that produces a counter-flow pattern that results in a significantly more uniform shelf temperature.

The upper shelf plate may be constructed of any suitable temperature conductive material, may be lighter than that of the lower shelf plate and may be mounted thereon or secured thereto in any suitable manner. In one embodiment, the upper shelf plate may be provided with apertures that are positioned and constructed to receive pins therethrough that extend upwardly from the lower shelf plate to enable the upper shelf plate to be mounted on the lower shelf plate in a simple and convenient manner that may be fixed or removable.

The use of a suitable lightweight material for the upper shelf plate improves heat transfer, reduces the cost, simplifies assembly of the upper and lower shelf plates, and provides a substantially uniform shelf temperature because of the serpentine pattern of the channels that produces a counter-flow.

### BRIEF DESCRIPTION OF THE DRAWINGS

FIG. 1 is a perspective view of one embodiment of a portion of a freeze dryer shelf that is constructed in accordance with the present invention.

FIG. 2 is a side elevational view of one embodiment of the freeze dryer shelf, with parts broken away; and

FIG. 3 is a side elevational view of a second embodiment of the freeze dryer shelf, with parts broken away;

FIG. 4 is a schematic plan view of a single wall shelf construction with the inlet and outlet near each other; and

FIG. 5 is a schematic plan view of a single wall shelf construction with the inlet and outlet spaced apart.

### DETAILED DESCRIPTION OF THE INVENTION

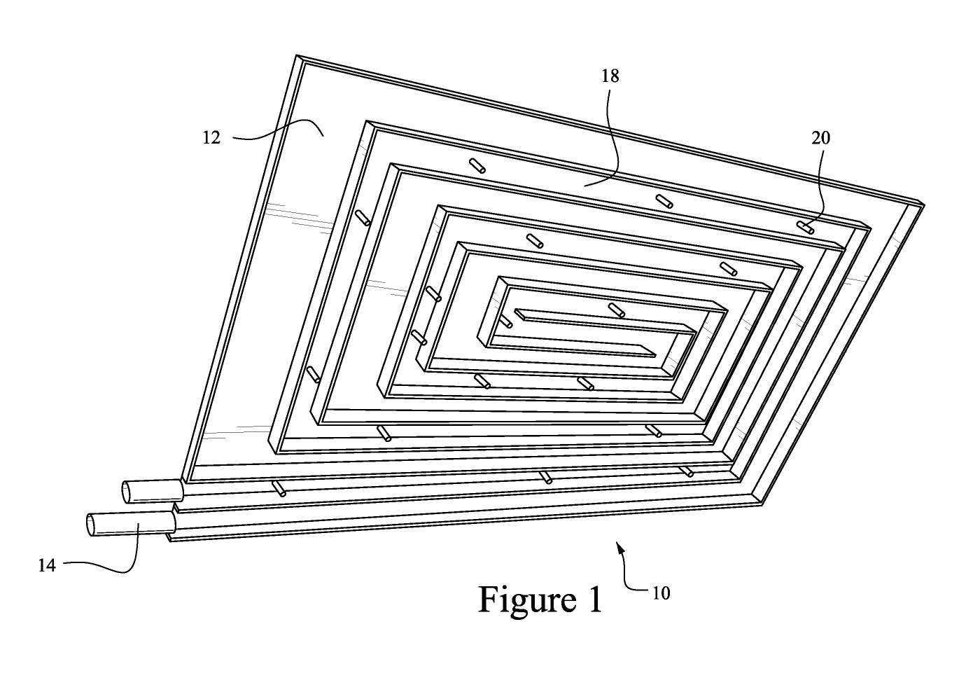

As shown in FIG. 1, the new and improved shelf 10 of the present invention is constructed to be mounted in any suitable manner in a cabinet or a housing (not shown) of a freeze dryer of any suitable construction.

The shelf 10 comprises an upper shelf plate 12 having piping 14 of any suitable type or location connected thereto for circulating a cooling or heating fluid through channels 18 formed of any suitable material and positioned between and attached to the upper shelf plate 12 and a lower shelf plate (not shown) in any suitable or desired manner. The upper shelf plate 12 may be formed of any suitable conductive material having suitable strength, such as stainless steel. The lower shelf plate may be formed of any suitable material such as stainless steel.

The serpentine pattern channels 18 are attached to both the lower shelf plate (not shown) and upper shelf plate 12 and are formed and secured thereto in any suitable manner, either fixedly or removably. The upper and lower shelf plates can be aligned and connected using pins 20, or any other suitable method, which extend upwardly from the lower plate (not shown) through the channels 18 and into the upper plate 12 through apertures. The channels 18 can be made of any suitable material and affixed in any suitable manner.

The upper shelf plate 12 can be made of a material that is lighter than that of the material of the lower shelf plate (not shown), such as a thin gage stainless steel, aluminum, plastic or another suitable material. The use of lighter and thinner materials for the upper shelf plate 12 reduces the temperature transition times and improves the heat transfer to product mounted on the upper shelf plate 12 for freeze drying.

The serpentine pattern of the channels 18 in the finished assembly provides a fluid path that produces a counter-flow pattern that results in a significantly more uniform shelf temperature which enhances a more uniform nucleation, freezing and drying of the product on the upper shelf plate 12. The serpentine pattern can be of any suitable configuration depending on the width and length of the shelf.

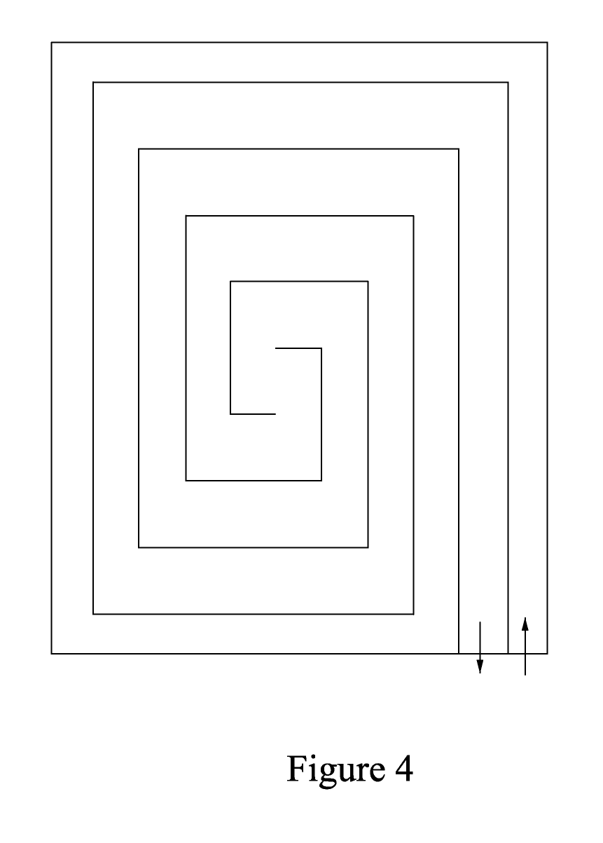

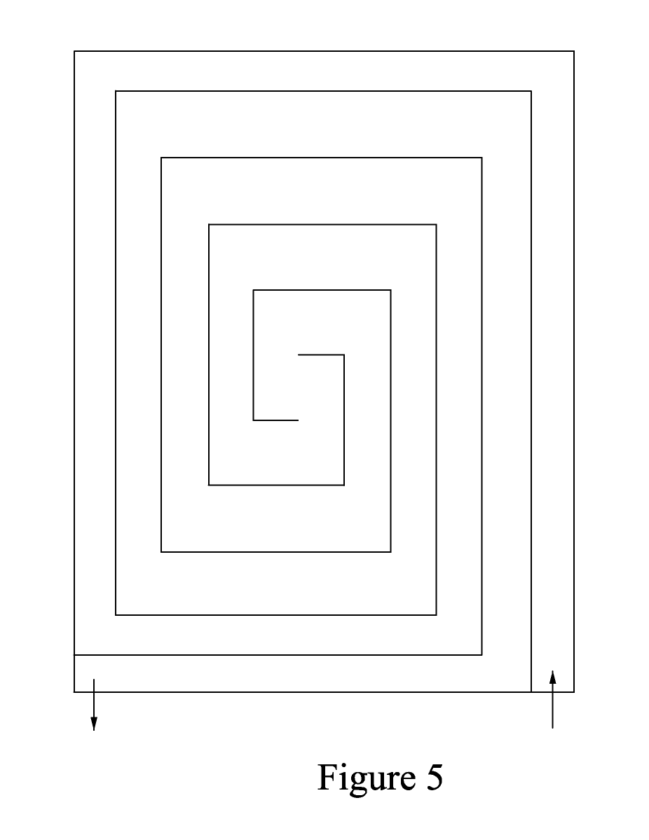

FIGS. 4 and 5 illustrate exemplary single wall shelf constructions with the serpentine pattern of the flow channels that produces a counter-flow or cross-flow. The flow channels can be provided for example, by single walls, U-tubes, square tubes or round tubes.

There may be applications where the shelf assembly is mounted in a reverse orientation, where it will work just as well. The unique use of serpentine channels in the present construction lends itself to the selectively modifying the channel sizes and configuration to improve heat transfer in specific areas. This may be required where the product on the shelf is not uniformly in contact with the shelf or when the shelf is mounted in a location that has significant external sources of heat or cooling.

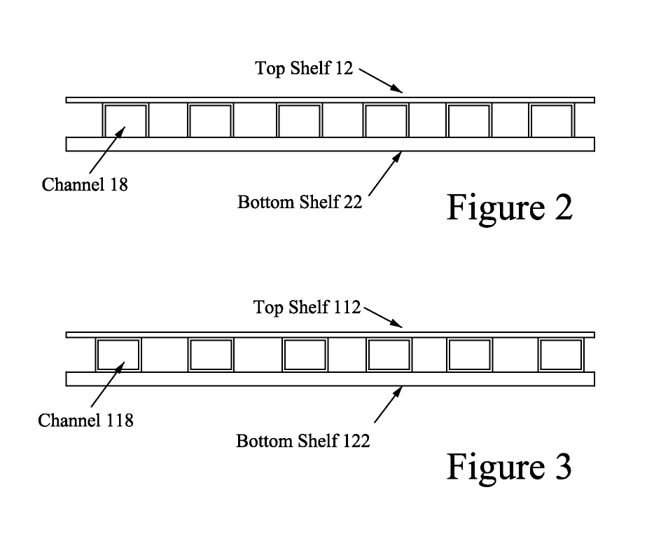

FIG. 2 illustrates the channels 18 in an open construction between the upper shelf plate 12 and the lower shelf plate 22.

FIG. 3 illustrates the channels 118 in a closed construction between the upper shelf plate 112 and the lower shelf plate 122.

From the foregoing description, it is apparent that the new and improved freeze dryer shelf construction and method of the present invention possess many advantages over conventional or presently used or known shelf constructions for freeze dryers, some of which are as follows:
1. The single layer counter-flow fluid path improves shelf temperature uniformity;
2. The shelf has fast responsiveness to fluid temperature change so as to minimize the time to reach temperature equilibrium;
3. In the case where the upper shelf plate is mounted on the lower shelf plate by pins, the upper shelf plate may be made of a different material;
4. The present shelf construction has an improved weight/strength ratio over that of known or prior art shelf constructions for freeze dryers;
5. The fabrication of the present shelf construction is much easier and less costly than that of currently known shelves for freeze dryers; and
6. The improved temperature uniformity improves the quality of the freeze dried product and enables reduced freeze drying process times.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A shelf for a freeze dryer that has channels therein constructed to produce a fluid counter-flow pattern resulting in significantly better temperature uniformity.

2. The shelf of claim 1 wherein the counter-flow pattern is a serpentine pattern.

3. A shelf for a freeze dryer, comprising:
a lower shelf plate;
an upper shelf plate mounted on said lower shelf plate; and
channels in a serpentine pattern positioned between said upper shelf plate and said lower shelf plate to circulate heating or cooling fluid in a counter-flow pattern therebetween for temperature uniformity;
said upper shelf plate being formed of a temperature conductive material.

4. The shelf of claim 3 wherein piping is connected to said upper shelf plate to provide heating or cooling fluid to said channels.

5. The shelf of claim 3 wherein said upper shelf plate is formed of a material that is lighter in weight than the material of the lower shelf plate.

6. The shelf of claim 5 wherein said lower shelf plate is formed of stainless steel, and said upper shelf plate is formed of aluminum, stainless steel or plastic.

7. The shelf of claim 3 wherein said serpentine channels extend from a peripheral portion of said upper and lower shelf plates to a center portion thereof.

8. The shelf of claim 3 wherein said upper shelf plate is fixedly mounted on said lower shelf plate.

9. The shelf of claim 3 wherein said upper shelf plate is removably mounted on said lower shelf plate.

10. The shelf of claim 3 wherein said lower shelf plate has a plurality of pins extending upwardly therefrom through said serpentine channels and into apertures in said upper shelf plate.

11. The shelf of claim 10 wherein said pins are formed of stainless steel.

12. A method for enhancing temperature uniformity across a shelf in a freeze dryer, comprising:
constructing the shelf with channels therein that create a counter flow of cooling or heating fluid across the shelf in a uniform manner.

13. The method of claim 12 wherein the counter flow is in a serpentine pattern across the shelf.
